(19) United States
(12) Patent Application Publication
(10) Pub. No.: US 2007/0253407 A1
(43) Pub. Date: Nov. 1, 2007

(54) Enhanced VoIP services

(75) Inventors: Kaunsan Wang, Bellevue, WA (US); Michael D. Malueg, Renton, WA (US); Philip A. Chou, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/415,323

(22) Filed: May 1, 2006

(51) Int. Cl. H04L 12/66

(52) U.S. Cl. 370/352

(57) ABSTRACT

A method and system for providing enhanced VoIP services relating to the use of callee rules and/or caller rules is provided. A callee may specify callee rules defining the callee preferences such as which VoIP device of the callee is appropriate for responding to an incoming communication from a specified caller. The callee rules may define a priority of VoIP devices of the callee, designating in which order the VoIP devices are to be notified of any incoming communication from a specified caller. Similarly, a caller can specify caller rules defining the caller preferences. The method and system compares the callee rules and the caller rules to establish a communication channel. As such, various enhanced VoIP services can be tailored based on the callee rules and the caller rules.

### BACKGROUND

Generally described, an Internet telephony system provides an opportunity for users to have a call connection with enhanced calling features compared to a conventional Public Switched Telephone Network (PSTN)-based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, ability to establish and control multimedia communication, and the like. VoIP technology will likely continue to gain favor because of its ability to provide enhanced calling features and advanced services which the traditional telephony technology has not been able to provide. However, current VoIP approaches may not provide client-tailored services based on client's preferences.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method and system for providing enhanced VoIP services relating to the use of callee rules and/or caller rules is provided. Any authorized VoIP entities are allowed to specify a set of rules for establishing a conversation channel. The callee may specify callee rules defining the callee preferences such as which VoIP device of the callee is appropriate for responding to an incoming communication from a specified caller. The appropriate VoIP device may correspond to a geographic location of the callee and/or a predetermined time of day. In addition, the callee rules may define a priority of VoIP devices of the callee, designating in which order the VoIP devices are to be notified of any incoming communication from a specified caller. Similarly, the caller can specify caller rules defining the caller preferences. The method and system compares the callee rules and the caller rules to establish a communication channel. As such, various enhanced VoIP services can be tailored based on the callee rules and the caller rules.

In accordance with an aspect of the invention, a method for establishing a communication channel for a conversation between a first client and a second client is provided. A computing device receives a request to initiate the communication channel from the first client. In response to the request, contextual information corresponding to a set of rules specified by the second client is obtained. Based on the contextual information, the computing device determines whether at least one client device of the second client is available for establishing the communication channel. If there is at least one client device of the second client available, the computing device establishes the communication channel between the first client and the second client using the at least one available client device.

In accordance with the method, the computing device further obtains contextual information relating to the request to initiate the communication channel from the first client. The computing device then compares the contextual information from the first client and the contextual information from the second client. The most appropriate client device will be selected from the available client devices for establishing the communication channel. In one embodiment, the computing device determines a priority of available client devices of the second client and selects the available client device with the highest priority as the most appropriate client device. In another embodiment, the computing device selects an available client device corresponding to the first client's contextual information which specifies a desired client device of the second client.

In accordance with another aspect of the invention, a computer-readable medium having computer-executable components for exchanging data packets relating to a conversation over a communication channel is provided. The computer-executable components include a channel connection component for initiating a communication channel in response to a request from a caller and for receiving the data packets, including contextual data packets and conversational data packets. The contextual data packets include information relating to a set of rules specified by the caller and the callee. The computer-executable components further include a contextual information processing component for processing the contextual data packets and identifying a priority list of callee client devices which are appropriate for a caller. The channel connection component establishes the communication channel connection between a client device of the caller and at least one client device of the callee identified in the priority list.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a VoIP environment for establishing a conversation channel between various clients in accordance with an aspect of the present invention;

FIG. 2 is a block diagram illustrative of a VoIP client in accordance with an aspect of the present invention;

FIG. 3 is a block diagram illustrative of various components associated with a VoIP device in accordance with an aspect of the present invention;

FIGS. 4A and 4B are block diagrams illustrative of the exchange of data between two VoIP clients over a conversation channel in accordance with an aspect of the present invention;

FIG. 5 is a block diagram of a data packet used over a communication channel established in the VoIP environment of FIG. 1;

FIG. 6 is a block diagram illustrating interactions between two VoIP clients for transferring contextual information defined by identified structured hierarchies in accordance with an aspect of the present invention;

FIGS. 7A, 7B, and 7C are block diagrams illustrating interactions among VoIP entities for establishing a communication channel in accordance with an aspect of the present invention;

FIGS. 8-12 are block diagrams illustrative of various attributes and classes of structured hierarchies corresponding to VoIP contextual information in accordance with an aspect of the present invention;

FIG. 13 is a flow diagram of a caller-channel establishing routine in accordance with an aspect of the present invention;

FIG. 14 is a flow diagram of a callee device determining subroutine used in the caller-channel establishing routine of FIG. 13 in accordance with an aspect of the present invention;

FIG. 15 is a flow diagram of a callee-channel establishing routine in accordance with an aspect of the present invention; and

FIG. 16 is a flow diagram of a callee device in priority list subroutine used in the callee-channel establishing routine of FIG. 15, in accordance with an aspect of the present invention.

### DETAILED DESCRIPTION

Generally described, the present invention relates to a method and system for processing contextual information relating to a conversation over a communication channel. More specifically, the present invention relates to a method and system utilizing contextual information including client rules in conjunction with “structured hierarchies”. “Structured hierarchies,” as used herein, are predefined organizational structures for arranging contextual information to be exchanged between two or more VoIP devices. For example, structured hierarchies may be XML namespaces. Further, a VoIP conversation includes one or more data streams of information related to a conversation, such as contextual information and voice/multimedia information, exchanged over a conversation channel. Although the present invention will be described with relation to illustrative structured hierarchies and an IP telephony environment with an emphasis on voice communication, one skilled in the relevant art will appreciate that the disclosed embodiments are illustrative in nature and should not be construed as limiting.

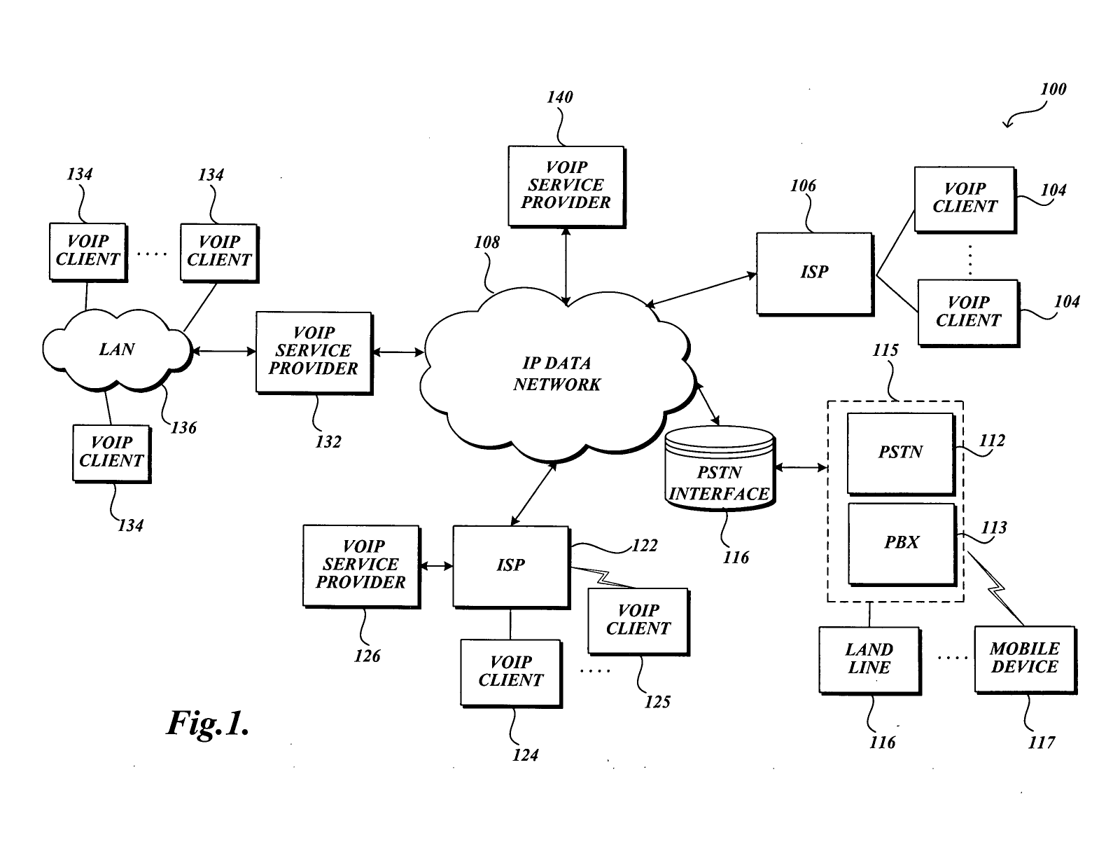

With reference to FIG. 1, a block diagram of an IP telephony environment 100 for providing IP telephone services between various “VoIP clients” is shown. A “VoIP client,” as used herein, refers to a particular contact point, such as an individual, an organization, a company, etc., one or more associated VoIP devices and a unique VoIP client identifier. For example, a single individual, five associated VoIP devices and a unique VoIP client identifier may collectively makeup a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live where each individual is associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108 such as the Internet, an intranet network, a wide area network (WAN), a local area network (LAN), and the like. The IP telephony environment 100 may further include VoIP service providers 126, 132 providing VoIP services to VoIP clients 124, 125, 134. A VoIP call conversation may be exchanged as a stream of data packets corresponding to voice information, media information, and/or contextual information. As will be discussed in greater detail below, the contextual information includes metadata (information of information) relating to the VoIP conversation, the devices being used in the conversation, the contact point of the connected VoIP clients, and/or individuals that are identified by the contact point (e.g., employees of a company).

The IP telephony environment 100 may also include third party VoIP service providers 140. The VoIP service providers 126, 132, 140 may provide various calling features, such as incoming call-filtering, text data, voice and media data integration, and the integrated data transmission as part of a VoIP call conversation. VoIP clients 104, 124, 125, 136 may create, maintain, and provide information relating to predetermined priorities for incoming calls. In addition, the VoIP service providers 126, 132, 140 may also generate, maintain, and provide a separated set of metadata information (e.g., provider priority list) for individuals communicating in a call conversation. The VoIP service providers 126, 132, 140 may determined and assign an appropriate priority level to data packets based on priority information provided by VoIP clients 104, 124, 125, 136 in conjunction with the provider priority list.

VoIP service providers 132 may be coupled to a private network such as a company LAN 136, providing IP telephone services (e.g., internal calls within the private network, external calls outside of the private network, and the like) and multimedia data services to several VoIP clients 134 communicatively connected to the company LAN 136. Similarly, VoIP service providers, such as VoIP service provider 126, may be coupled to Internet Service Provider (ISP) 122, providing IP telephone services and VoIP services for clients of the ISP 122.

In one embodiment, one or more ISPs 106, 122 may be configured to provide Internet access to VoIP clients 104, 124, 125 so that the VoIP clients 104, 124, 125 can maintain conversation channels established over the Internet. The VoIP clients 104, 124, 125 connected to the ISP 106, 122 may use wired and/or wireless communication lines. Further, each VoIP client 104, 124, 125, 134 can communicate with Plain Old Telephone Service (POTS) 115 via PSTN 112, or Private Branch exchange (PBX) 113. A PSTN interface 114 such as a PSTN gateway may provide access between POTS/PSTN and the IP data network 108. The PSTN interface 114 may translate VoIP data packets into circuit switched voice traffic for PSTN and vice versa. The PSTN 112 may include a land line device 116, a mobile device 117, and the like.

Conventional voice devices, such as land line 116 may request a connection with the VoIP client based on the unique client identifier of that client and the appropriate VoIP device associated with the VoIP client, will be used to establish a connection. In one example, an individual associated with the VoIP client may specify which devices are to be used in connecting a call based on a variety of conditions (e.g., connection based on the calling party, the time of day, etc.).

It is understood that the above-mentioned configuration in the environment 100 is merely exemplary. It will be appreciated by one of ordinary skill in the art that any suitable configurations with various VoIP entities can be part of the environment 100. For example, VoIP clients 134 coupled to LAN 136 may be able to communicate with other VoIP clients 104, 124, 125, 134 with or without VoIP service providers 132 or ISP 106, 122. Further, an ISP 106, 122 can also provide VoIP services to its client.

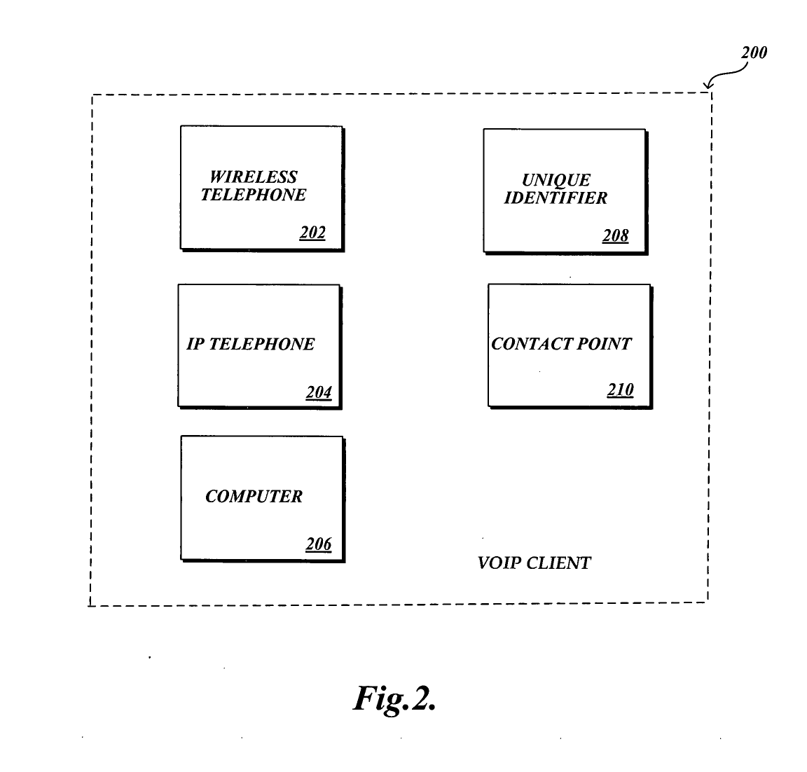

Referring now to FIG. 2, a block diagram illustrating an exemplary VoIP client 200 that includes several VoIP devices and a unique client identifier, in accordance with an embodiment of the present invention, is shown. Each VoIP device 202, 204, 206 may include storage that is used to maintain voice messages, address books, client specified rules, priority information related to incoming calls, etc. Alternatively, or in addition thereto, a separate storage, maintained for example by a service provider, may be associated with the VoIP client and accessible by each VoIP device that contains information relating to the VoIP client. In an embodiment, any suitable VoIP device such as a wireless phone 202, an IP phone 204, or a computer 206 with proper VoIP applications may be part of the VoIP client 200. The VoIP client 200 also maintains one or more unique client identifier 208. The unique client identifier(s) 208 may be constant or change over time. The unique client identifier is used to identify the client and to connect with the contact point 210 associated with the VoIP client. The unique client identifier may be maintained on each VoIP device included in the VoIP client and/or maintained by a service provider that includes an association with each VoIP device included in the VoIP client. In the instance in which the unique client identifier is maintained by a service provider, the service provider may include information about each associated VoIP device and knowledge as to which device(s) to connect for incoming communications. In an alternative embodiment, the VoIP client 200 may maintain multiple client identifiers where a unique client identifier may be temporarily assigned to the VoIP client 200 for each call session.

The unique client identifier may be used similar to a telephone number in PSTN. However, instead of dialing a typical telephone number to ring a specific PSTN device, such as a home phone, the unique client identifier is used to reach a contact point, such as an individual or company, which is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS client using a personal computer (VoIP device), the VoIP client identification number in conjunction with an IP address of the personal computer will eventually be converted into a telephone number recognizable in PSTN.

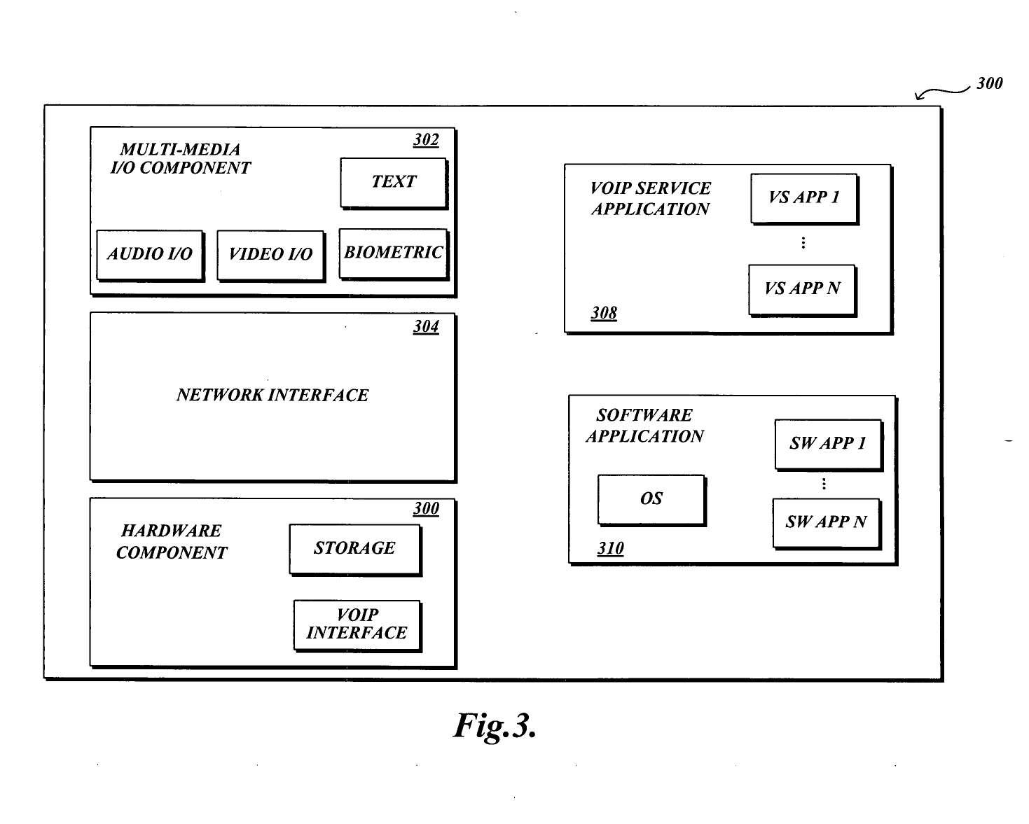

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting and processing various types of data packets. For example, the VoIP device 300 may include a multimedia input/output component 302 and a network interface component 304. The multimedia input/output component 302 may be configured to input and/or output multimedia data (including audio, video, and the like), user biometrics, text, application file data, etc. The multimedia input/output component 302 may include any suitable user input/output components such as a microphone, a video camera, a display screen, a keyboard, user biometric recognition devices, and the like. The multimedia input/output component 302 may also receive and transmit multimedia data via the network interface component 304. The network interface component 304 may support interfaces such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage such as read-only memory devices (ROM), random access memory (RAM), hard drives, optical drives, and the like. The storage may be configured to store program instructions for controlling the operation of an operating system and/or one or more applications and to store contextual information related to individuals (e.g., voice profiles) associated with the VoIP client in which the device is included. In one embodiment, the hardware component 306 may include a VoIP interface card which allows non-VoIP client device to transmit and receive a VoIP conversation.

The device 300 may further include a software application component 310 for the operation of the device 300 and a VoIP Service application component 308 for supporting various VoIP services. The VoIP service application component 308 may include applications such as data packet assembler/disassembler applications, a structured hierarchy parsing application, audio Coder/Decoder (CODEC), video CODEC and other suitable applications for providing VoIP services. The CODEC may use voice profiles to filter and improve incoming audio.

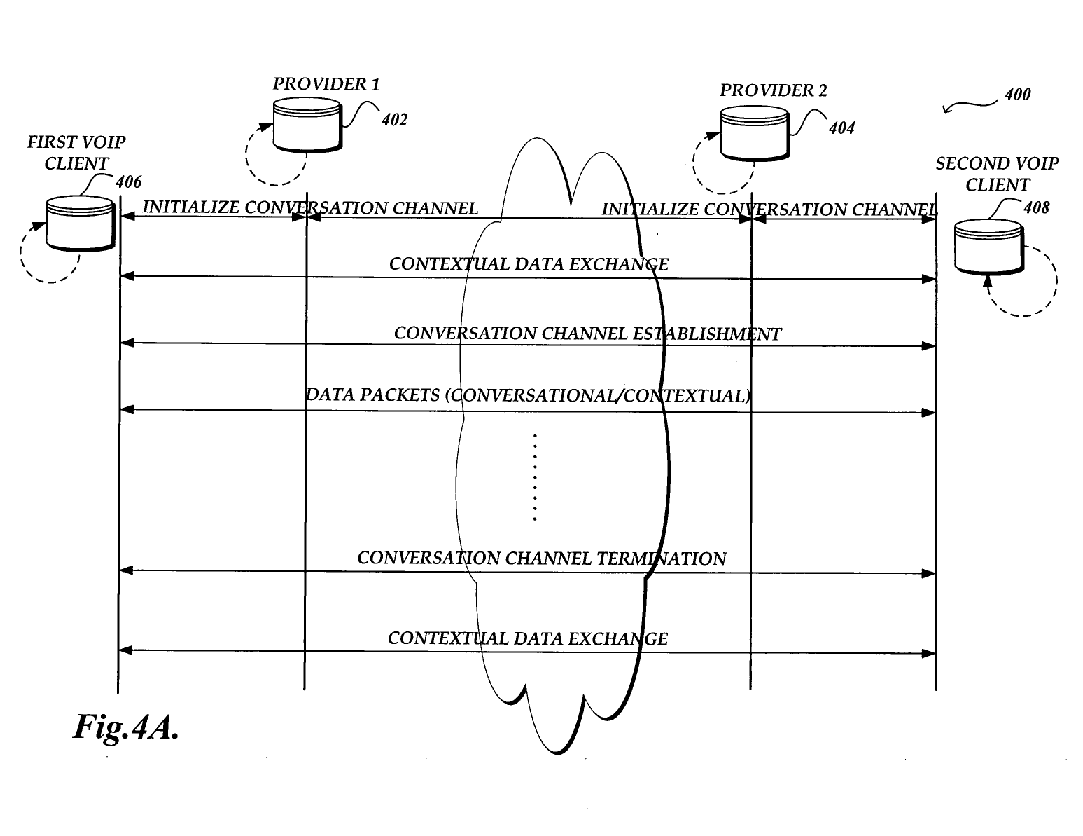

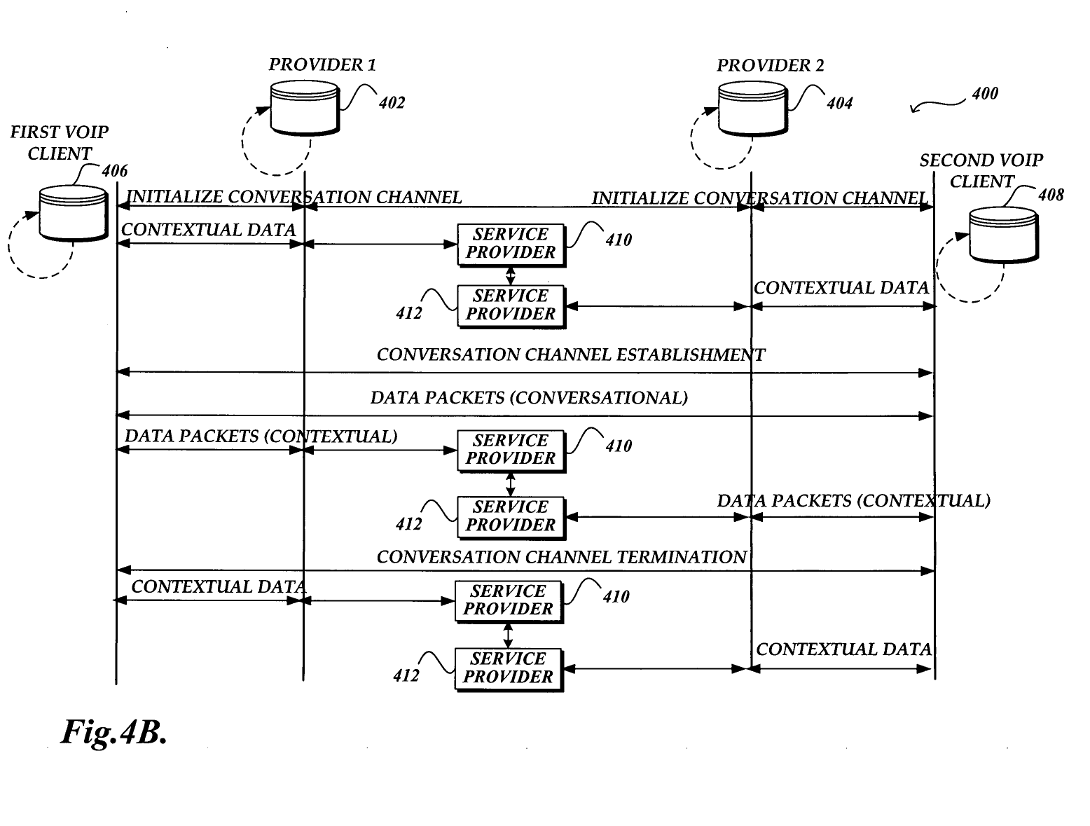

With reference to FIG. 4A, a block diagram illustrative of a conversation flow 400 between VoIP devices of two different VoIP clients over a conversation channel, in accordance with an embodiment of the present invention, is shown. During a connection set-up phase, a VoIP device of a first VoIP client 406 requests to initiate a conversation channel with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 406. While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer to peer context, communication between VoIP devices may also be direct without having any service providers involved.

There are a variety of protocols that may be selected for use in exchanging information between VoIP clients, VoIP devices, and/or VoIP service providers. For example, when Session Initiation Protocol (SIP) is selected for a signaling protocol, session control information and messages will be exchanged over a SIP signaling path/channel and media streams will be exchanged over Real-Time Transport Protocol (RTP) path/channel. For the purpose of discussion, a communication channel, as used herein, generally refers to any type of data or signal exchange path/channel. Thus, it will be appreciated that depending on the protocol, a connection set-up phase and a connection termination phase may require additional steps in the conversation flow 400.

For ease of explanation, we will utilize the example in which both the first VoIP client 406 and the second VoIP client 408 each only include one VoIP device. Accordingly, the discussion provided herein will refer to connection of the two VoIP devices. The individual using the device of the first VoIP client 406 may select or enter the unique client identifier of a client that is to be called. Provider 1 402 receives the request from the device of the first VoIP client 408 and determines a terminating service provider (e.g. Provider 2 404 of the second VoIP client 408) based on the unique client identifier included in the request. The request is then forwarded to Provider 2 404. This call initiation will be forwarded to the device of the second VoIP client. A conversation channel between the device of the first VoIP client 406 and a device of the second VoIP client 408 can then be established.

In an illustrative embodiment, before the devices of the first VoIP client 406 and the second VoIP client 408 begin to exchange data packets, contextual information may be exchanged. As will be discussed in a greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client 406, the device, and the VoIP client 408 being called. More specifically, contextual information may include information relating to a set of rules (defined by the calling VoIP client 406, or the called VoIP client 408), a priority list for devices, and the like. For example, a callee (e.g. VoIP client 408) can specify a priority of devices for incoming calls and designate a certain device to answer incoming calls based on geographic location, time of day, callee biometrics, etc. Further, a callee can define a set of rules to seamlessly transfer of a call from one device to another under certain conditions.

Available media types, rules of the calling client and the client being called, and the like, may also be part of the contextual information that is exchanged during the connection set-up phase. The contextual information may be processed and collected by one the devices of the first VoIP client 406, one of the devices of the second VoIP client 408, and/or by VoIP service providers (e.g. Provider 1 402 and Provider 2 404), depending on the nature of the contextual information. In one embodiment, the VoIP service providers 402, 404 may add/or delete some information to/from the client's contextual information before forwarding the contextual information.

In response to a request to initiate a conversation channel, the second VoIP client 408 may accept the request for establishing a conversation channel or execute other appropriate actions such as rejecting the request via Provider 2 404. The appropriate actions may be determined based on the obtained contextual information. When a conversation channel is established, a device of the first VoIP client 406 and a device of the second VoIP client 408 start communicating with each other by exchanging data packets. As will be described in greater detail, the data packets, including conversation data packets and contextual data packets, are communicated over the established conversation channel between the connected devices.

Conversation data packets carry data related to a conversation, for example, a voice data packet, or multimedia data packet. Contextual data packets carry information relating to data other than the conversation data. Once the conversation channel is established, either the first VoIP client 406 or the second VoIP client 408 can request to terminate the conversation channel. Some contextual information may be exchanged between the first VoIP client 406 and the second VoIP client 408 after the termination.

FIG. 4B is a block diagram illustrative of a conversation flow 400 between devices of two VoIP clients via several service providers, in accordance with an embodiment of the present invention. As with FIG. 4A, the example described herein will utilize the scenario in which each client only has one device associated therewith and the connection occurs between those two devices. During a connection set-up phase, a device of a first VoIP client 406 requests to initiate a conversation channel for communication with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 408.

Before the device of the first VoIP client 406 and the device of the second VoIP client 408 begin to exchange voice data packets, contextual information may be exchanged between the first VoIP client 406 and the second VoIP client 408. Contextual information may be exchanged using a structured organization defined by the first VoIP client 406. In one embodiment, Provider 1 402 may identify particular contextual information which Provider 1 402 desires to obtain from the first VoIP client 406. The first VoIP client 406 may specify the corresponding structure based on the content of the contextual information. The identification of the structure for exchanging information and additional contextual information may be transmitted to the second VoIP client 408 via Provider 2 404 and Provider 1 402.

The contextual information may be processed and collected at a device of the first VoIP client, a device of the second VoIP client, and/or the VoIP service providers (e.g., Provider 1 and Provider 2), depending on the nature of the contextual information. For example, voice profiles may be collected by the service providers 402, 404, and only temporarily provided to the devices. Further, third party Service Provider(s) (third party SP) 410, 412 can obtain and/or add contextual information exchanged among devices of the first VoIP client 406 and second VoIP client 408, Provider 1 402, and Provider 2 404. In one embodiment, any of Provider 1 402, Provider 2 404, and third party SP 410, 412 may add, modify and/or delete contextual information before forwarding the contextual information to the next VoIP device(s), including other service providers.

More specifically, any of Provider 1 402, Provider 2 404, and third party SP 410, 412 may provide or forward a set of rules for VoIP client 408 or VoIP client 406, a priority list for devices, and the like. For example, a central database server (e.g., third party SP 410) may maintain contextual information relating to VoIP clients (e.g., VoIP client 408 or VoIP client 406) and authorization information. In this example, when contextual information need to be obtained, any authorized VoIP entity may query the contextual information from the central database server which may maintain a database of contextual information.

In response to a request to initiate a conversation channel, the second VoIP client 408 may accept the request for establishing a conversation channel or reject the request via Provider 2 404. When a conversation channel has been established, the devices of the first VoIP client 406 and the second VoIP client 408 start communicating with each other by exchanging data packets as discussed above. In one embodiment, contextual and/or conversation data packets may be forwarded to third party SPs 410, 412 from Provider 1 402, Provider 2 404, or from either VoIP client 406, 408. Further, the forwarded contextual and/or conversation data packets may be exchanged among various third party SPs 410, 412.

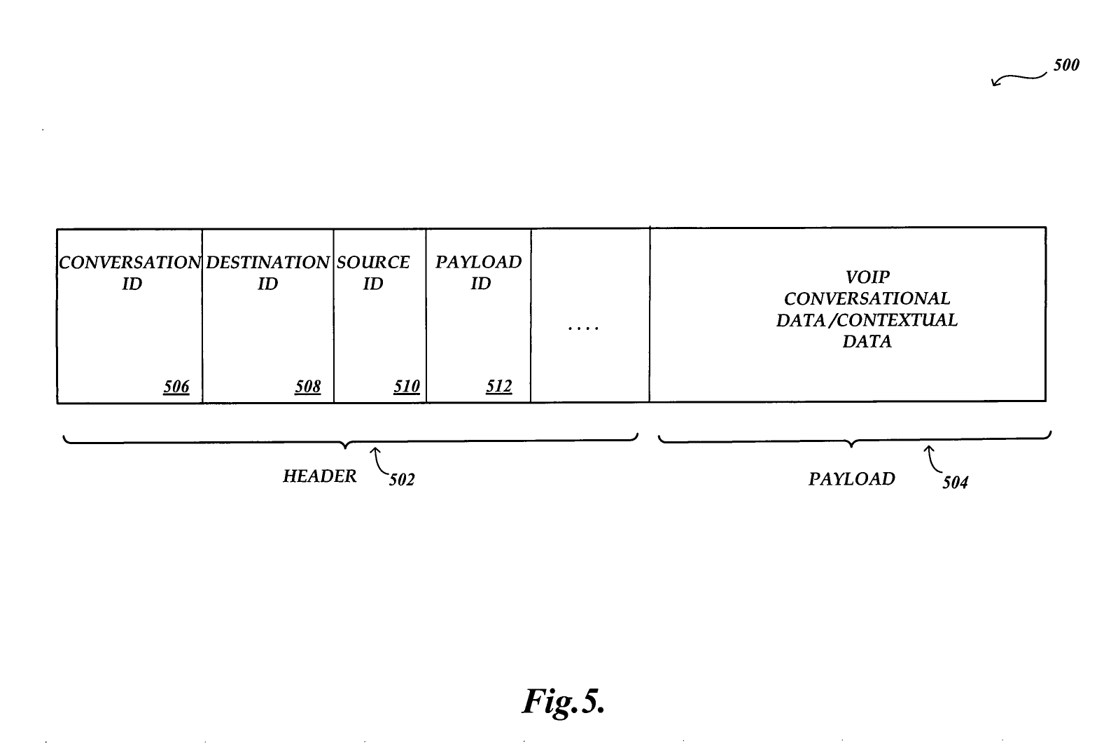

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services, and the like). However, any other suitable data structure can be utilized to carry conversation data or contextual data. The data packet structure 500 includes a header 502 and a payload 504. The header 502 may contain information necessary to deliver the corresponding data packet to a destination. Additionally, the header 502 may include information utilized in the process of a conversation. Such information may include conversation ID 506 for identifying a conversation (e.g., call), a Destination ID 508, such as a unique client identifier of the client being called, a Source ID 510 (unique client identifier of the calling client or device identifier), Payload ID 512 for identifying type of payload (e.g., conversation or contextual), individual ID (not shown) for identifying the individual for which the conversation data is related, and the like. In an alternative embodiment, the header 502 may contain information regarding Internet protocol versions, and payload length, among others. The payload 504 may include conversational or contextual data relating to an identified conversation. As will be appreciated by one of ordinary skill in the art, additional headers may be used for upper layer headers such as a TCP header, a UDP header, and the like.

In one embodiment of the present invention, a structured hierarchy may be predefined for communicating contextual information over a VoIP conversation channel. The contextual information may include any information relating to VoIP clients, VoIP devices, conversation channel connections (e.g., call basics), conversation context (e.g., call context), and the like. More specifically, the contextual information may include client preference, client rules, client's location (e.g., user location, device location, etc.), biometrics information, the client's confidential information, VoIP device's functionality, VoIP service providers information, media type, media parameters, calling number priority, keywords, information relating to application files, and the like. The contextual information may be processed and collected at each VoIP client and/or the VoIP service providers depending on the nature of the contextual data. In one aspect, the VoIP service providers may add, modify and/or delete VoIP client's contextual data before forwarding the contextual information. For example, client's confidential information will be deleted by the VoIP service provider associated with that client unless the client authorizes such information to be transmitted. In some cases, a minimal amount of contextual information is transmitted outside of an intranet network.

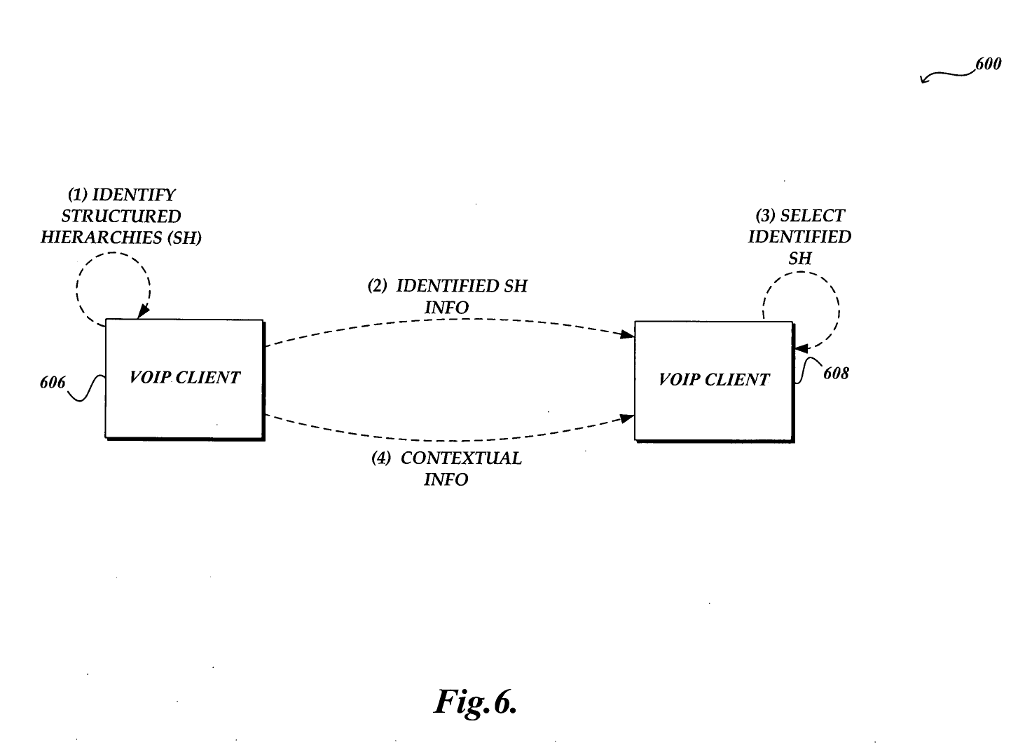

With reference to FIG. 6, a block diagram 600 illustrating interactions between two VoIP clients for transferring contextual information, in accordance with an embodiment of the present invention, is shown. As with FIGS. 4A and 4B, the example described herein will utilize the scenario in which each client only has one device associated therewith and the connection occurs between those two devices. In one embodiment, devices of VoIP client 606 and VoIP client 608 have established a VoIP conversation channel. It may be identified which structured hierarchies will be used to carry certain contextual information by VoIP client 606. The information regarding the identified structured hierarchies may include information about which structured hierarchies are used to carry the contextual information, how to identify the structured hierarchy, and the like. Such information will be exchanged between VoIP client 606 and VoIP client 608 before the corresponding contextual information is exchanged. Upon receipt of the information about which structured hierarchy is used to carry the contextual information, VoIP client 608 looks up predefined structured hierarchies (e.g., XML namespace and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP client 606 to VoIP client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated and thus the amount of transmitted data packets corresponding to the contextual data is reduced. Further, by employing the predefined structured hierarchies, data packets can be transmitted in a manner which is independent of hardware and/or software.

Upon retrieving the identified structured hierarchy, VoIP client 608 is expecting to receive a data stream such that data packets corresponding to the data stream are defined according to the identified structured hierarchies. VoIP client 606 can begin sending contextual information represented in accordance with the identified structured hierarchies. In one embodiment, VoIP client 608 starts a data binding process with respect to the contextual information. For example, instances of the identified structured hierarchies may be constructed with the received contextual information.

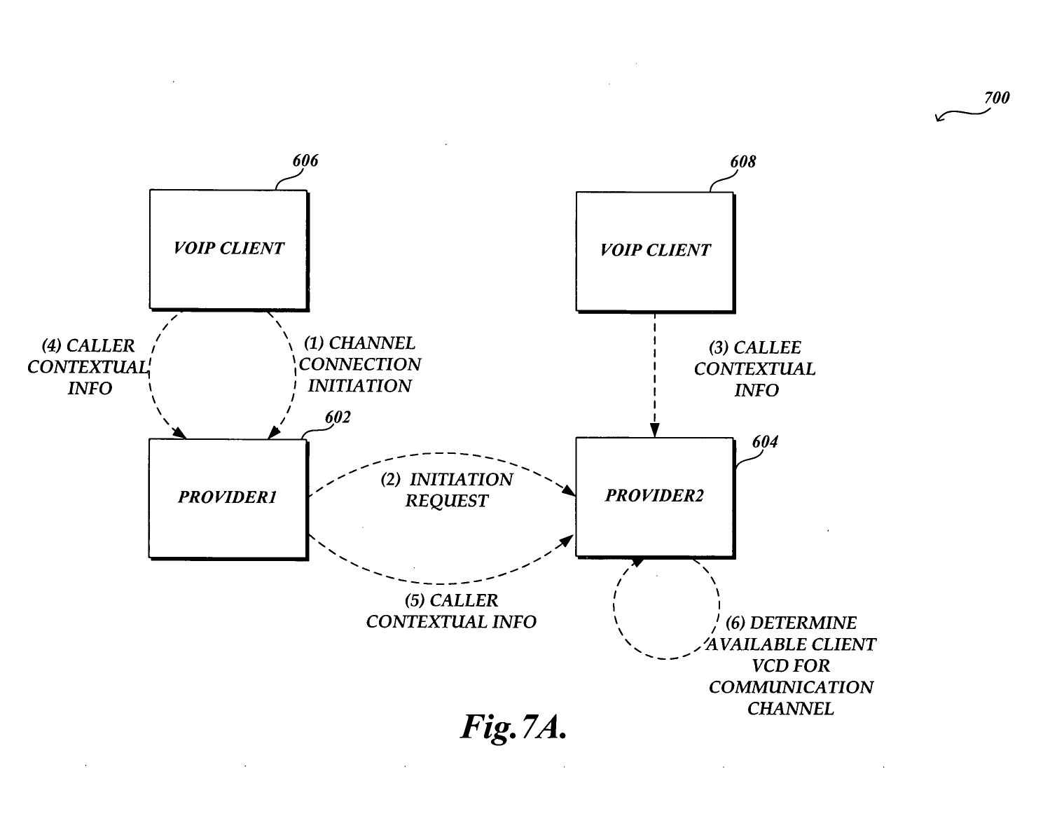

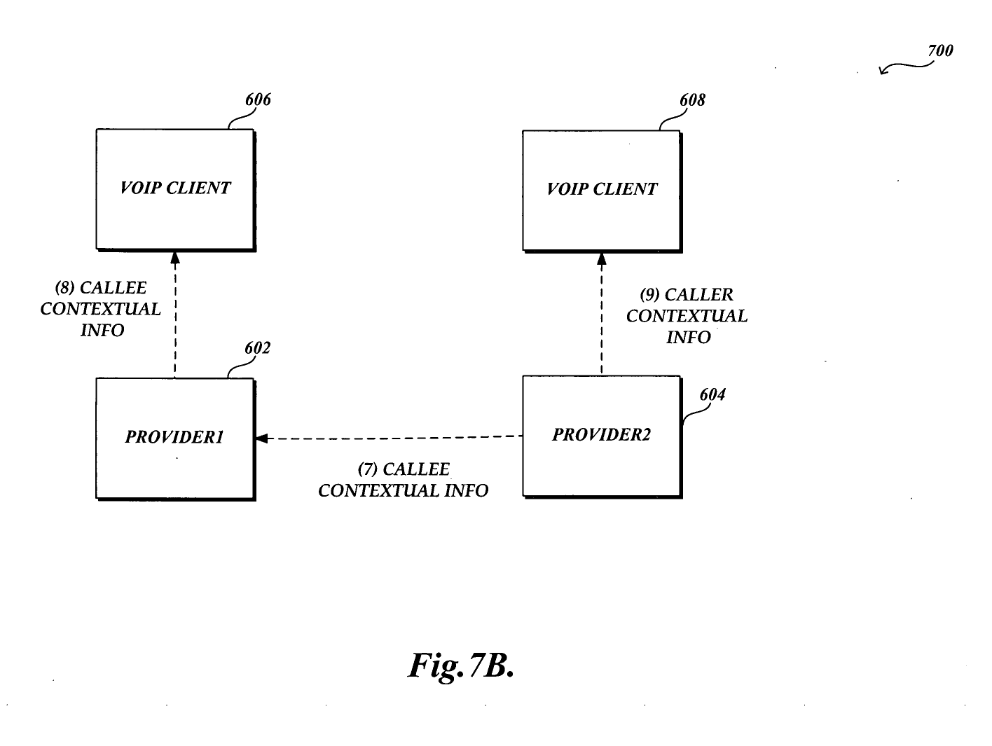

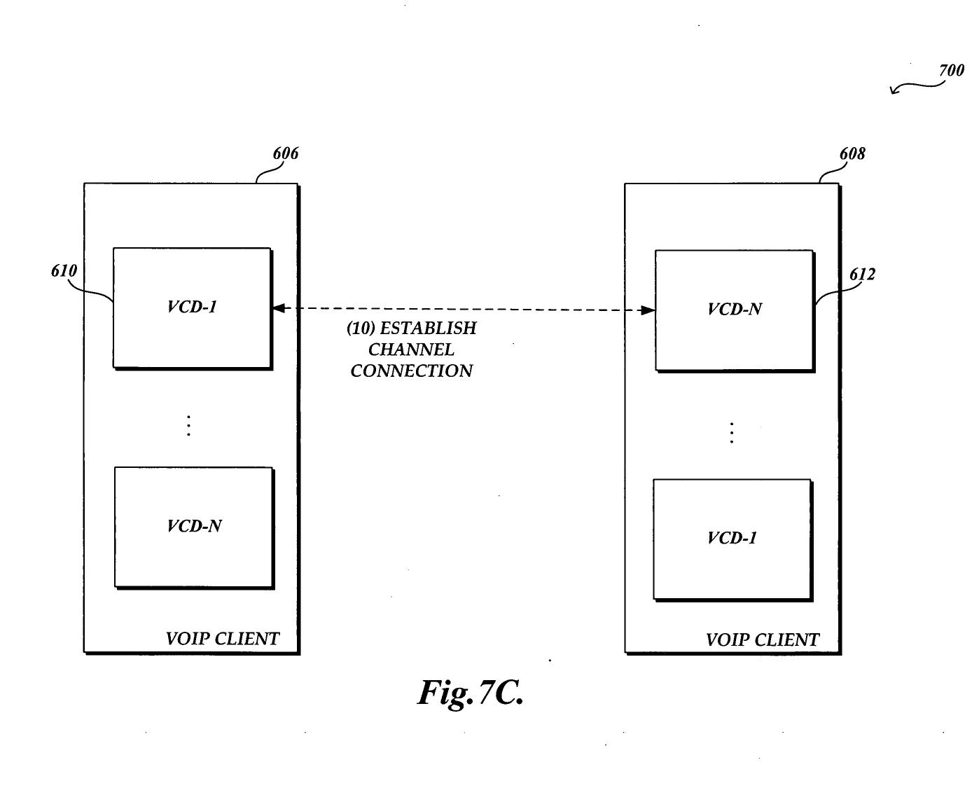

With reference to FIGS. 7A, 7B, and 7C, block diagrams 600 illustrate interactions among VoIP entities for establishing or maintaining a communication channel in accordance with an aspect of the present invention. The VoIP entities may include VoIP clients 606, 608, VoIP service providers 602, 604, third party service providers, and the like. In one embodiment, a third party service provider may receive contextual information of VoIP clients 606, 608 from VoIP service providers 602, 604. For discussion purposes, assume that VoIP client 606 has Provider 1 602 for the VoIP service provider and VoIP client 608 has Provider 2 604 for the VoIP service provider. While this example utilizes two VoIP service providers and two VoIP clients, any number and combination of VoIP clients and/or service providers may be used with embodiments of the present invention.

Referring now to FIG. 7A, in one embodiment, VoIP client 606 requests Provider 1 602 to initiate a communication channel connection between VoIP client 606 and VoIP client 608. Provider 1 602, the originating service provider, forwards the request to initiate a communication channel connection to Provider 2 604, a terminating service provider of such request. One of skill in the relevant art will appreciate that if the callee (e.g., VoIP client 606) and the caller (e.g., VoIP client 608) share one service provider, the originating service provider and the terminating service provider for a VoIP call are the same. Further, devices of VoIP client can communicate with each other without any service providers involved, for example, in peer-to-peer context. As described above, upon receipt of the request, Provider 2 604 may identify contextual information which will be obtained from VoIP client 608. Then, VoIP client 608 collects the identified contextual information and identifies structured hierarchies which will be used to carry the identified contextual information. In one embodiment, VoIP client 608 collects contextual information relating to the request and transmits the contextual information along with the request.

With continued reference to FIG. 7A, Provider 2 604 obtains the callee contextual information including information relating to a set of rules specifying available devices, a priority list of the available devices, and the like. The callee contextual information may be obtained from the callee, or any VoIP entity that is capable of providing the callee contextual information. Similarly, Provider 1 602 obtains the caller's contextual information including information relating to a set of rules specifying desired callee devices, and additional caller's preferences, from VoIP client 606. In one embodiment, a caller can designate a specific type of callee devices for a communication channel. For example, a caller may require a connection with a callee device that is capable of playing multimedia content. Provider 1 602 may forward the obtained caller contextual information to Provider 2 604. In one embodiment, Provider 1 602 may collect more contextual information, if necessary, and update the received contextual information. For example, Provider 1 602 may add information relating to services provided for VoIP client 606, such as billing information, rates, and the like.

In one embodiment, the information regarding structured hierarchies identified for the contextual information may be exchanged among VoIP client 606, Provider 1 602, Provider 2 604, and VoIP client 608. The information regarding the identified structured hierarchies may include information about which structured hierarchies are used to carry the contextual information, how to identify the structured hierarchies, and the like. Provider 2 604 may process the received contextual information based on the identified structured hierarchies and determine which callee devices are available and which priority list of the callee devices is appropriate for the incoming call request. Upon processing the contextual information, Provider 2 604 selects an appropriate client device for the communication channel, based on various information such as the set of rules specifying appropriate callee devices, geographic locations, predetermined times, and the like.

In an alternative embodiment, Provider 1 602 may obtain callee's contextual information and select an appropriate callee device for the communication channel, based on various information such as the set of rules specifying appropriate callee devices, geographic locations, predetermined times, and the like. The appropriate callee device information will be transmitted to Provider 2 606 or directly to VoIP client 608.

Referring now to FIG. 7B, Provider 2 604 may forward the obtained caller contextual information from VoIP client 608 to Provider 1 602. Provider 1 602 may forward the information regarding the identified structured hierarchies and the callee contextual information to VoIP client 606. In one embodiment, Provider 1 602 processes the callee contextual information based on the identified structured hierarchies, and collects, and stores subsets of the processed contextual information. In an alternative embodiment, the information regarding the identified structured hierarchies and the callee/caller contextual information may be forwarded to a third party service provider. In an illustrative embodiment, the structured hierarchies may be defined by Extensible Markup Language (XML). However, it is to be appreciated that the structured hierarchies can be defined by any language suitable for implementing and maintaining extensible structured hierarchies. Generally described, XML is well known as a cross-platform, software and hardware independent tool for transmitting information. Further, XML maintains its data as a hierarchically structured tree of nodes, each node comprising a tag that may contain descriptive attributes. XML is also well known for its ability to allow extendable (i.e. vendor customizable) patterns that may be dictated by the underlying data being described without losing interoperability. Typically, an XML namespace URI is provided to uniquely identify a namespace. In some instances, the namespace may be used as a pointer to a centralized location containing default information (e.g. XML Schema) about the document type the XML is describing.

In an illustrative embodiment, VoIP client 606 may identify a XML namespace for contextual information. When multiple contexts are aggregated, appropriate XML namespaces can be declared as an attribute at the corresponding tags. It is to be understood that XML namespaces, attributes, and classes illustrated herein are provided merely as an example of structured hierarchies used in conjunction with various embodiments of the present invention. After VoIP client 608 receives the XML namespace information, the VoIP client 606 transmits a set of data packets containing contextual information defined in accordance with the identified XML namespace or namespaces to VoIP client 608. When a namespace is present at a tag, its child elements share the same namespace in pursuant to the XML scope rule defined by XML 1.0 specification. As such, VoIP client 608 and VoIP client 606 can transmit contextual information without including prefixes in all the child elements.

With reference to FIG. 7C, a communication channel connection is established between VCD-1 of VoIP client 606 and VCD-N of VoIP client 608. As will be discussed in greater detail below, VoIP client 606 may have specified the caller rules requiring a desired client device of VoIP client 608 for a VoIP call. If the desired client device specified by VoIP client 606 is available, or is part of a priority list specified by VoIP client 608, the desired client device may be selected as the most appropriate client device. As such, the most appropriate client device will be selected for the communication channel connection, based on the caller rules and the callee rules.

For the purpose of discussion, assume a scenario that VoIP client 608 has specified two priority lists for VoIP client 606 which include a first priority list of devices having VCD-N with priority level 3, VCD-4 with priority level 2, and VCD-2 with priority level 1 and a second priority list of devices having VCD-1 with priority level 3, VCD-3 with priority level 2, VCD-N with priority level 1. VoIP client 608 has also specified that the first priority list will apply if VoIP client 608 is calling from an office downtown and that the second priority list will apply if VoIP client 608 is calling from home. In this example, VoIP client 606 may use one of devices (e.g. VCD-1) to request a communication channel connection between VoIP client 606 and VoIP client 608. The request to initiate may be forwarded to Provider 2 604 which is a VoIP service provider of VoIP client 608. When Provider 2 604 receives the request to initiate the communication channel connection, Provider 2 604 obtains contextual information (callee's contextual information) from VoIP client 608. The callee's contextual information may include the above-mentioned priority lists, a set of callee rules, preferences, device related information, and the like. Subsets of the obtained callee's contextual information will be processed, collected, modified and/or stored by Provider 2 604. Provider 1 602 obtains the caller contextual information from VoIP client 606 and forwards the caller's contextual information to Provider 2 604. In one embodiment, VoIP client 606 may transmit the caller's contextual information directly to Provider 2 604. VoIP client 606 may also transmit the caller's contextual information directly to VoIP client 608 in a peer-to-peer context.

In this illustrative embodiment, Provider 2 604 may obtain the location information of VoIP client 608 in order to determine which priority list for VoIP client 606 will be used. The location information may be already included in the obtained callee's contextual information. Otherwise, Provider 2 604 may obtain the location information from an appropriate source such as a GPS server, a location information server, VoIP client 608, etc. Upon obtaining the location information, Provider 2 604 may select a priority list in accordance with the callee rules and the location information. For example, if VoIP client 608 is located downtown at the office, Provider 2 604 checks whether any of the devices in the first priority list is available for the communication channel, and selects a device with the highest priority from the available devices. For instance, if the callee devices such as VCD-N and VCD-2 are available, in accordance with the first priority list, VCD-N with priority level 3 will be selected over VCD-2 which has priority level 1. In this illustrative embodiment, a communication channel connection is established between VCD-1 of the VoIP client 606 and VCD-N of VoIP client 608. As such, VoIP client 606 and VoIP client 608 can start communicating via VCD-1 of the VoIP client 606 and VCD-N of VoIP client 608.

For the purpose of discussion, assume another scenario that VoIP client 608 has specified a general priority list of available devices including VCD-N (e.g., first mobile phone), VCD-4 (e.g., computer), VCD-3 (e.g., pager), and VCD-2 (e.g., second mobile phone) for incoming calls from any VoIP clients and that VoIP client 606 has requested to initiate a communication channel between VoIP client 606 and VoIP client 608. In an illustrative embodiment, VoIP client 606 sends the request to initiate a communication channel. Provider 1 602 may forward the request to initiate to Provider 2 604 which provides VoIP services for VoIP client 608. When Provider 2 604 receives the request to initiate the communication channel from Provider 1 602, Provider 2 604 obtains contextual information (callee's contextual information) from VoIP client 608. The contextual information, including the general priority list, will be processed by Provider 2 604. The caller's contextual information (including caller rules, preferences, current conditions, device information, and the like) may also be obtained from VoIP client 606, or Provider 1 602. If Provider 2 604 may find VoIP client 608 in downtown at the office, Provider 2 604 checks whether any of the devices in the general priority list are available for a communication channel, and selects a device with the highest priority from the available devices. For instance, if there are no devices available, Provider 2 604 will select an appropriate actions. For example, Provider 2 604 may reject the request to initiate a communication channel. Subsequently, a notification of the rejection with a relevant reason may be transmitted to VoIP client 606, or Provider 1 604.

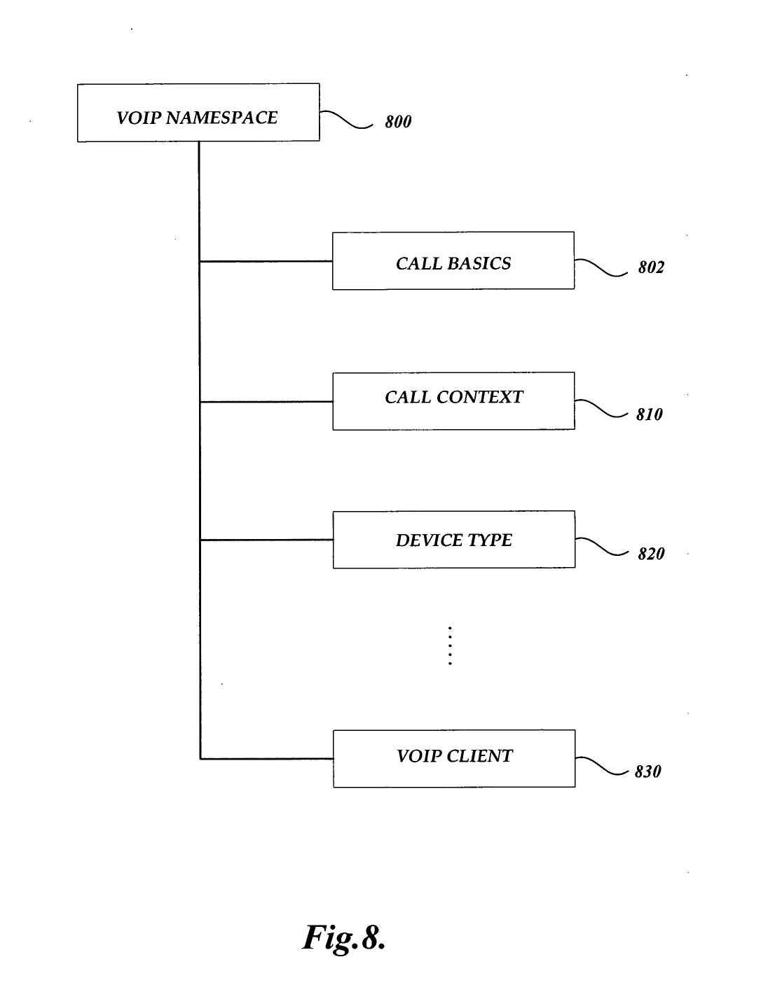

With reference to FIGS. 8-12, block diagrams illustrative of various classes and attributes of structured hierarchies corresponding to VoIP contextual information are shown. The VoIP contextual information exchanged between various VoIP entities (e.g., clients, service providers, etc.) may correspond to a VoIP namespace 800. In one embodiment, the VoIP namespace 800 is represented as a hierarchically structured tree of nodes, each node corresponding to a subclass which corresponds to a subset of VoIP contextual information. For example, a VoIP Namespace 800 may be defined as a hierarchically structured tree comprising a Call Basics Class 802, a Call Contexts Class 810, a Device Type Class 820, a VoIP Client Class 830, and the like.

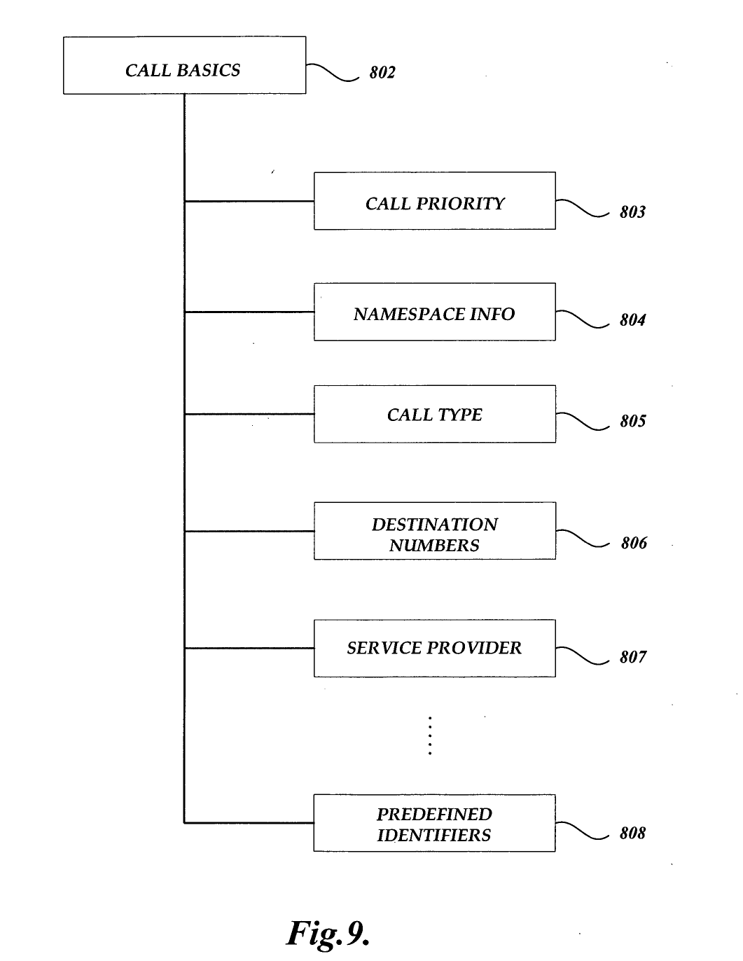

With reference to FIG. 9, a block diagram of a Call Basics Class 802 is shown. In an illustrative embodiment, Call Basics Class 802 may correspond to a subset of VoIP contextual information relating to a conversation channel connection (e.g., a PSTN call connection, a VoIP call connection, and the like). The subset of the VoIP contextual information relating to a conversation channel connection may include originating numbers (e.g., a caller's unique client number), destination numbers (e.g., callees' unique client numbers or telephone numbers), call connection time, VoIP service provider related information, and/or ISP related information such as IP address, MAC address, namespace information, and the like. Additionally, the contextual information relating to a conversation channel connection may include call priority information (which defines the priority levels of the destination numbers), call type information, and the like. The call type information may indicate whether the conversation channel is established for an emergency communication, a broadcasting communication, a computer to computer communication, a computer to POTS device communication, and so forth. In one embodiment, the contextual information relating to a conversation channel connection may include predefined identifiers which represent emotions, sounds (e.g., “ah”, “oops”, “wow”, etc.) and facial expressions in graphical symbols. In one embodiment, a Call Basics Class 802 may be defined as a sub-tree structure of a VoIP Namespace 800, which includes nodes such as call priority 803, namespace information 804, call type 805, destination numbers 806, service provider 807, predefined identifiers 808, and the like.

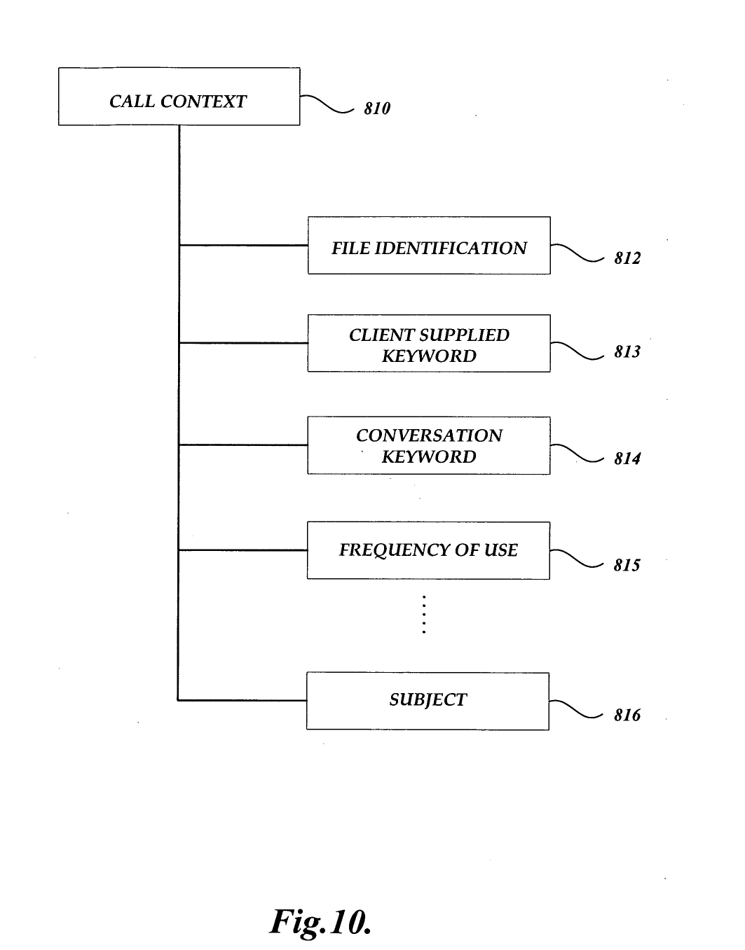

With reference to FIG. 10, a block diagram of a Call Contexts Class 810 is shown. In one embodiment, a subset of VoIP contextual information relating to conversation context may correspond to the Call Contexts Class 810. The contextual information relating to conversation context may include information such as client supplied keywords, identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation), among many others. In accordance with an illustrative embodiment, a Call Contexts Class 810 may be defined as a sub-tree structure of a VoIP Namespace 800, which includes nodes corresponding to file identification 812, client supplied keyword 813, conversation keyword 814, frequency of use 815, subject of the conversation 816, and the like.

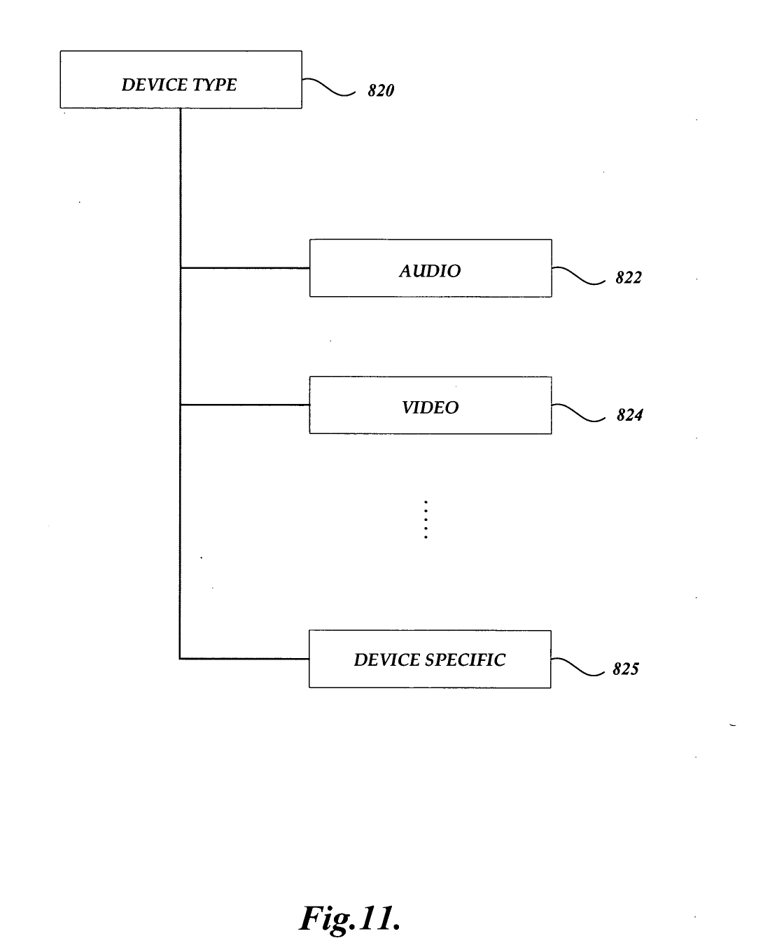

With reference to FIG. 11, a block diagram of a Device Type Class 820 is depicted. In one embodiment, a Device Type Class 820 may correspond to a subset of VoIP contextual information relating to a VoIP client device used for the conversation channel connection. The subset of the VoIP contextual information relating to the VoIP client device may include audio related information which may be needed to process audio data generated by the VoIP client device. The audio related information may include information related to the device's audio functionality and capability, such as sampling rate, machine type, output/input type, microphone, Digital Signal Processing (DSP) card information, and the like. The subset of the VoIP contextual information relating to the VoIP client device may include video related information which may be needed to process video data generated by the VoIP client device. The video related information may include resolution, refresh, type and size of the video data, graphic card information, and the like. The contextual information relating to VoIP client devices may further include other device specific information such as a type of the computer system, processor information, network bandwidth, wireless/wired connection, portability of the computer system, processing settings of the computer system, and the like. In an illustrative embodiment, a Device Type Class 820 may be defined as a sub-tree structure of a VoIP Namespace 800, which includes nodes corresponding to Audio 822, Video 824, Device Specific 826, and the like.

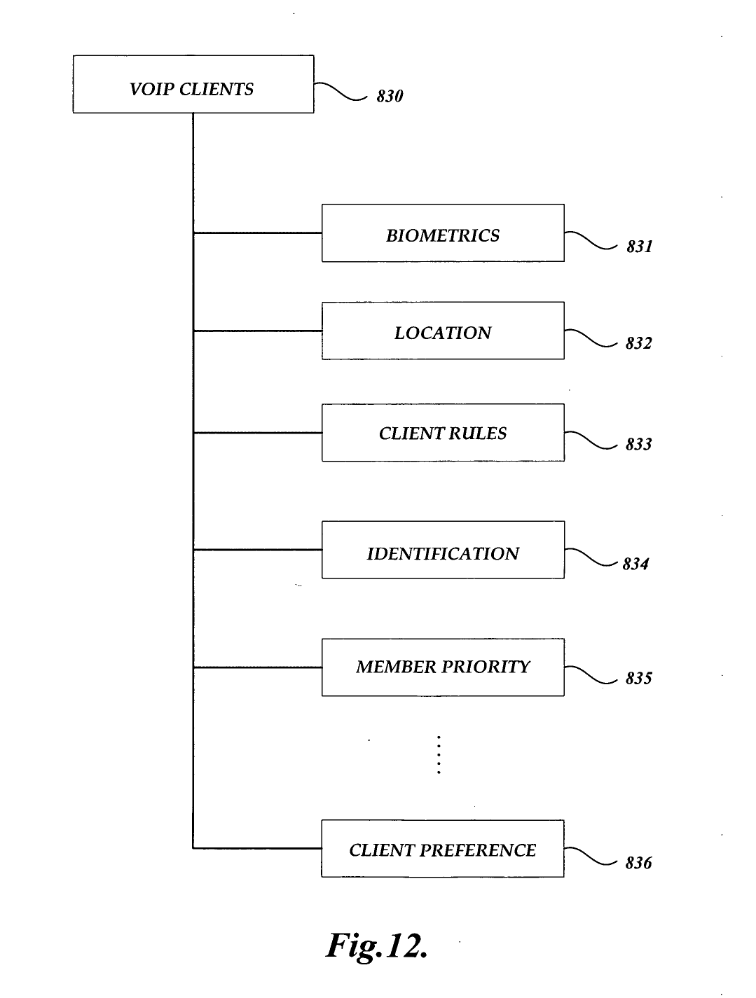

With reference to FIG. 12, a block diagram of a VoIP Client Class 830 is depicted. In accordance with an illustrative embodiment, a VoIP Client Class 830 may correspond to a subset of contextual information relating to VoIP clients. In one embodiment, the subset of the VoIP contextual information relating to the VoIP client may include voice profile information (e.g., a collection of information specifying the tonal and phonetic characteristics of an individual user), digital signature information, and biometric information. The biometric information can include user identification information (e.g., fingerprint) related to biometric authentication, user stress level, user mood, etc. Additionally, the subset of the VoIP contextual information relating to the VoIP client may include location information (including a client defined location, a VoIP defined location, a GPS/triangulation location, and a logical/virtual location of an individual user), assigned phone number, user contact information (such as name, address, company, and the like), rules defined by the client, user preferences, digital rights management (DRM), a member rank of an individual user in an organization, priority associated with the member rank, and the like. The priority associated with the member rank may be used to assign priority to the client for a conference call. In one embodiment, a VoIP Client Class 830 may be defined as a sub-tree structure of a VoIP Namespace 800, which includes nodes corresponding to user biometrics 831, location 832, client rules 833, user identification 834, member priority 835, user preference 836, and the like.

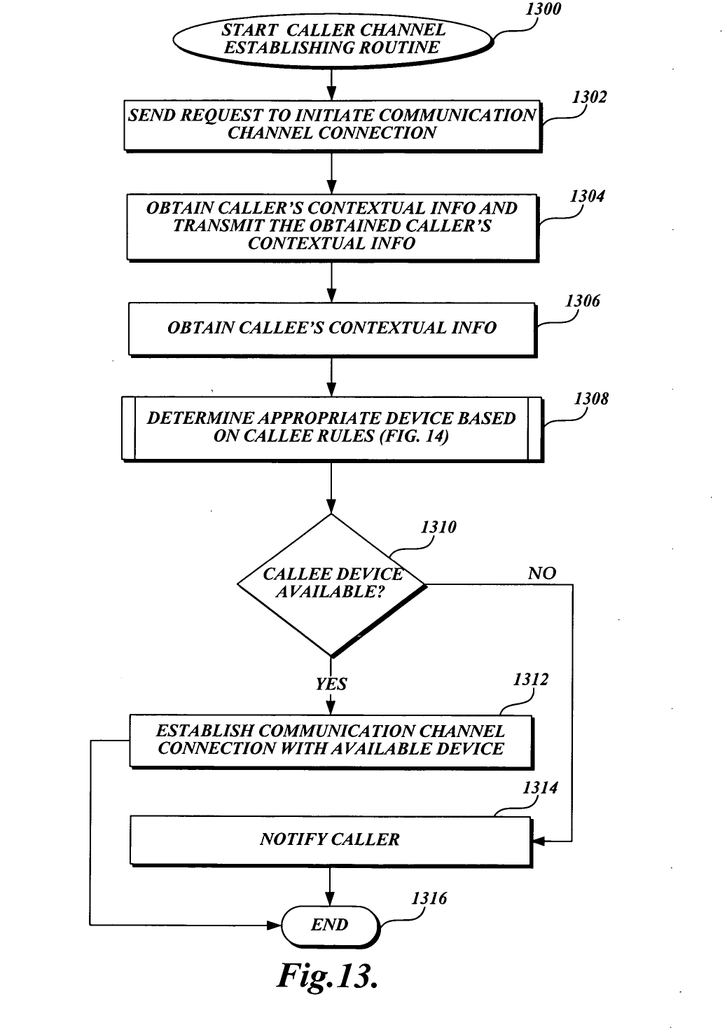

FIG. 13 is a flow diagram of a caller-channel establishing routine 1300 in accordance with an embodiment of the present invention. Although the illustrative embodiment is described herein in connection with the routine 1300 and focused on interactions during a connection set-up phase, it is contemplated that client's contextual information can be exchanged at any time, including before establishing a communication channel (e.g., during a connection set-up phase), during a conversation, or after terminating a communication channel. Further, based on rules of clients, other contextual information relating to maintaining or terminating a communication channel, may be exchanged among various VoIP entities.

Beginning at block 1302, a caller (calling VoIP client) sends a request to initiate a communication channel with a callee (called VoIP client). More specifically, a device of the caller may send a request to initiate a communication channel with a callee. At block 1304, a service provider (service provider of the caller) obtains the caller's contextual information and transmits the obtained caller's contextual information to the callee. At block 1306, the service provider may also obtain the callee's contextual information. The contextual information may be provided by a service provider of the callee, the callee, and/or a third party service provider. As mentioned above, the callee's contextual information may also include a set of rules defined by the callee (callee rules), callee preferences, the service provider or a third party service provider. The callee rules may further define a list of appropriate devices for a named caller and a priority list of the appropriate devices for incoming calls from the named caller, among others. Some of the callee rules can be specific to geographic information of the callee or a certain device. Further, some of the callee rules can be specific to the date and time information when the communication channel connection is requested. Likewise, the caller's contextual information may include information related to the caller, such as the caller's billing information, identification information such as a unique client ID corresponding to the caller, and caller preferences, the caller's current conditions, device related information, etc.

In one embodiment, the service provider of the callee may maintain previously obtained callee contextual information in a database, local storage, etc. In this embodiment, the service provider of the callee may request the callee to provide only the changed parts of the callee's contextual information.

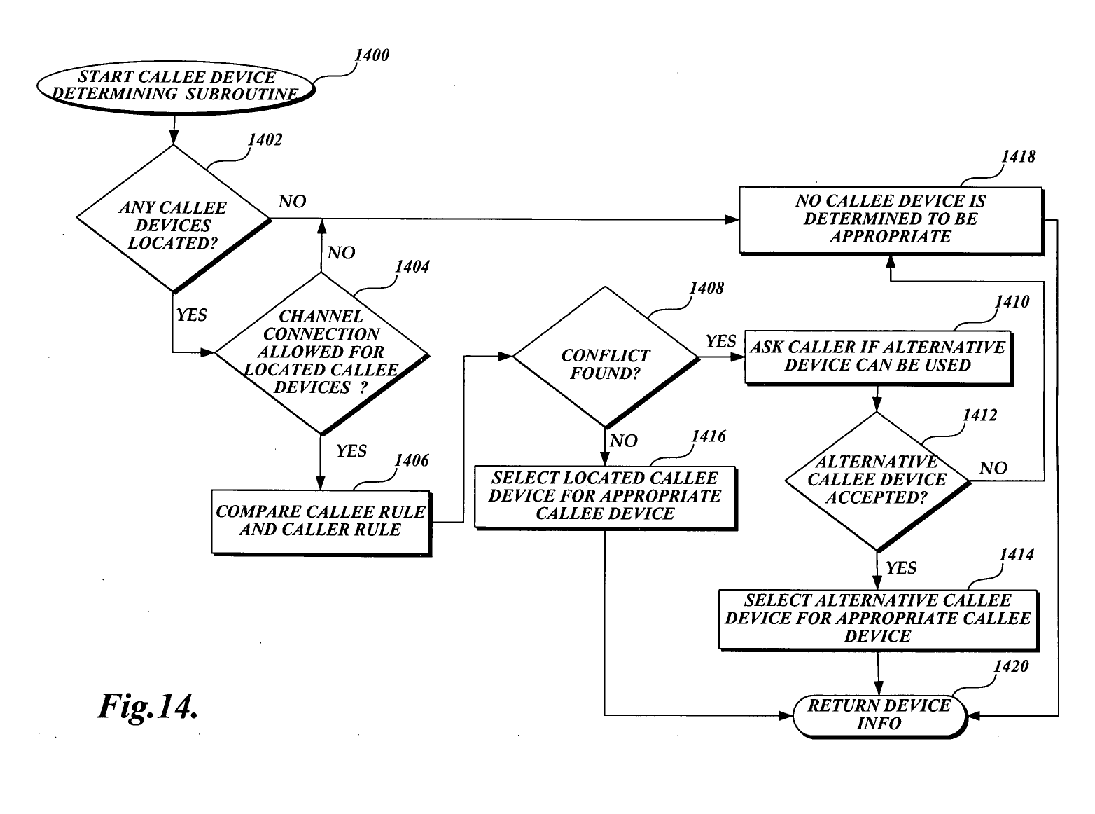

At block 1308, an appropriate callee device is determined and selected based on the set of rules defined by the callee (e.g., callee rules) utilizing a subroutine 1400. (See FIG. 14). At decision block 1310, a determination is made as to whether there is any available callee device for the communication channel. A device may be determined as an unavailable device when the device is powered off, not currently operating, in use, or prohibited for a conversation by the callee rules. If it is determined at decision block 1310 that at least one available callee device is located, the communication channel connection is established between the caller and the selected callee device at block 1312. If it is determined at decision block 1310 that no available callee device is located, the request for a communication channel is rejected and the caller may be notified about the rejection at block 1316.

FIG. 14 is a flow diagram illustrating a subroutine 1400 for determining and selecting available callee devices, used in the caller-channel establishing routine 1300, in accordance with an embodiment of the present invention. The routine 1400 starts with decision block 1402 to determine whether at least one operating callee device has been located (found). If it is determined that one or more operating callee devices are located, at decision block 1404, a determination is made as to whether the located callee devices are allowed to be utilized for a communication channel. As described above, the callee may have specified the callee rules relating to, for example, a communication channel, devices which are allowed for receiving incoming calls, a priority list, etc. The callee's contextual information corresponding to the callee rules may be provided to the service provider. The callee's contextual information may be processed to extract the callee rules. Based on the callee rules, the service provider may determine which devices of the callee are allowed for use in establishing a communication channel between the callee and the caller.

If it is determined at decision block 1404 that the located callee devices are allowed for establishing a communication channel between the callee and the caller, the callee rules and the caller rules are compared at block 1406. In one embodiment, the caller may specify caller rules designating a device of the caller for a communication channel. In some instances, the designated device of the callee may not be allowed for a communication channel, based on the callee rules. In such a case, the service provider may compare the caller rules and the callee rules in order to determine whether the callee rules and the caller rules conflict. Subsequently, the next appropriate devices may be determined based on the callee rules and caller rules.

At decision block 1408, a determination is made as to whether the caller rules and the callee rules agree with each other, or any conflict is found from the comparison of the callee rules and the caller rules. As mentioned above, the caller can specify a desired callee device for the communication channel and the callee can specify an appropriate callee device for the caller which is different from the desired callee device. If it is determined at decision block 1408 that the caller rules and the callee rules conflict, at block 1410, the service provider checks with the caller if an alternative device can be used for the communication channel. In one embodiment, in the caller rules, the caller may specify that any alternative device can be used when the designated callee device is not available.

At decision block 1412, a determination is made as to whether the caller allows using the alternative callee device other than the desired device. The alternative callee device is one of the available callee devices. If it is determined at decision block 1412 that the caller allows using the alternative callee device, the alternative callee device is selected as an appropriate device for the communication channel at block 1414. If it is determined at decision block 1412 that the caller does not allow use of an alternative callee device, at block 1418, no callee device is determined to be appropriate for the communication channel connection. If it is determined at decision block 1408 that the caller rules and the callee rules do not conflict, at block 1416, one of the available callee devices may be selected as an appropriate device based one the callee rules and the caller rules.

Further, if it is determined at decision block 1404 that none of the located callee devices are available for a communication channel or if it is determined at decision block 1402 that no callee device is located (found), at block 1418, no callee device is determined to be appropriate for the communication channel connection. Information regarding the selected callee device (at block 1414, or block 1416), or information indicating that no device is determined to be appropriate (at block 1418) may be returned and completes at block 1420.

It is to be understood that the embodiments explained in conjunction with the routine 1300 and the subroutine 1400 are provided merely for example purposes. It is contemplated that the routine 1300 and the subroutine 1400 can also be performed by VoIP clients or third party service provider. For example, a callee can obtain contextual information relating to a caller and select an appropriate callee device based on the callee rules and the caller rules. Other additional information can be obtained from the callee, service providers, third party service providers, and the like. Subsets of the obtained contextual information and the additional information will be transmitted to a service provider or third party service provider from the callee. In one embodiment, devices of the callee and the caller may directly communicate each other. It is further contemplated that the callee or the caller can switch from one to the other devices during a conversation based on the rules and the current conditions of the callee and the caller.

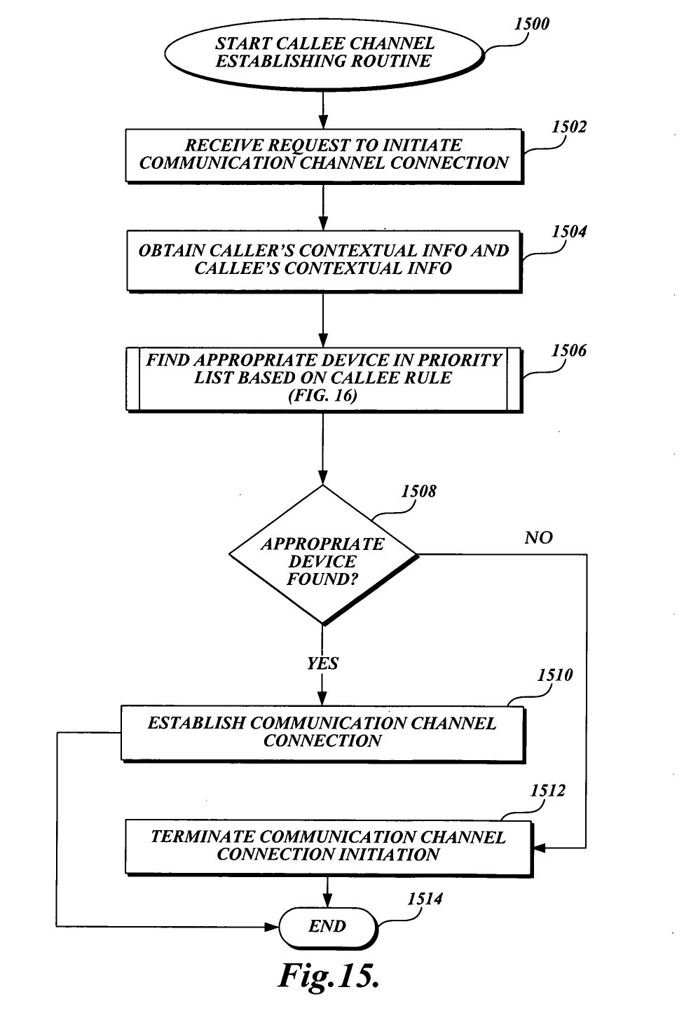

FIG. 15 is a flow diagram illustrating a callee-channel establishing routine 1500 in accordance with an embodiment of the present invention. Beginning at block 1502, the service provider receives a request to initiate a communication channel between the caller and the callee. At block 1504, the service provider obtains callee contextual information and obtains caller contextual information from the caller. As mentioned above, the caller contextual information may include information related to the caller, such as the caller's billing information, caller identification information including unique client ID, and caller preferences, among others. The callee's contextual information specifically includes callee rules, and other preferences of the callee. The callee rules may define a list of appropriate devices for a certain caller and a priority list of the appropriate devices, among others. A set of the callee rules may correspond to geographic information of the callee or a specific device. Further, the callee rules may correspond to date and time information pertinent to when the communication channel connection is being requested. In one embodiment, the service provider may have store contextual information that is previously obtained from the callee. In this embodiment, the service provider may request the callee to provide any contextual information which has been changed from the previously obtained contextual information.

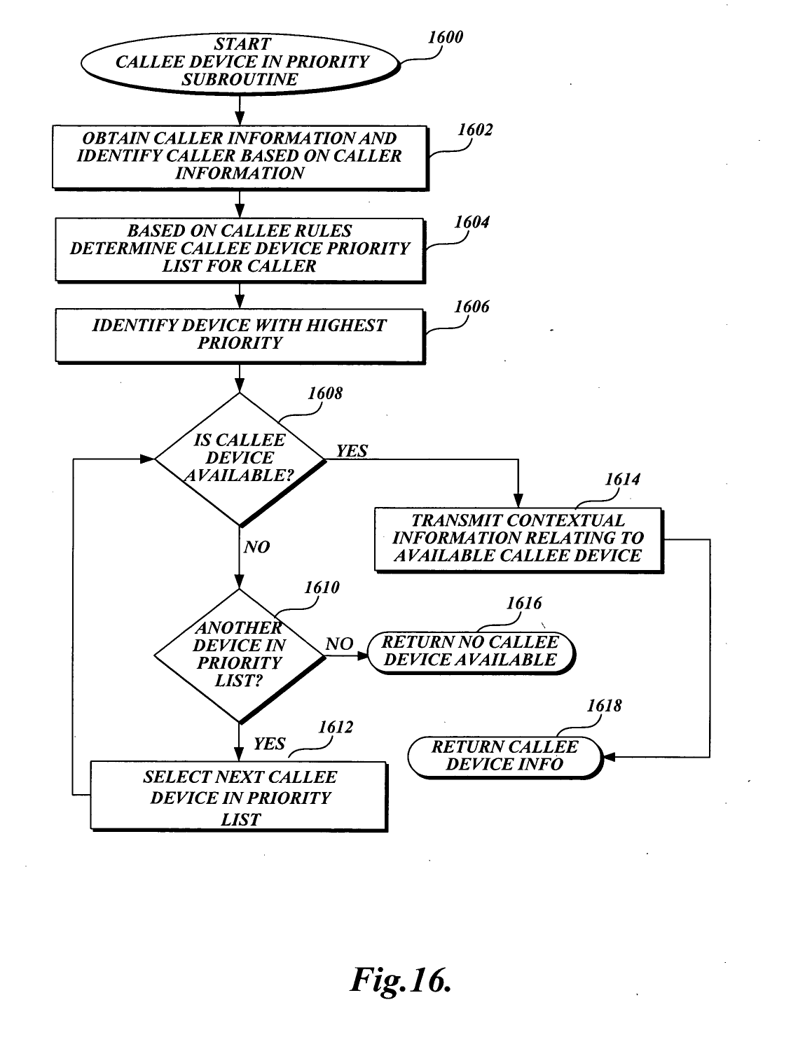

At subroutine block 1506, based on the callee rules, at least one appropriate callee device in a priority list is searched and selected utilizing a callee device in priority subroutine 1600. (See FIG. 16). At decision block 1508, a determination is made as to whether an appropriate callee device is identified for the communication channel. If at least one appropriate callee device is determined and selected, the communication channel connection is established between the caller and the appropriate callee device at block 1510. If no callee device is determined to be appropriate, at block 1512, the service provider rejects the request to initiate a communication channel and no communication channel connection is established between the caller and the callee. The routine 1500 completes at block 1514.

FIG. 16 is a flow diagram illustrating subroutine 1600 for determining and selecting an appropriate callee device for the communication channel. Beginning with block 1602, a service provider obtains caller's contextual information and identifies the caller, based on the caller's contextual information. At block 1604, the service provider determines a priority list of callee devices for the caller. As mentioned above, the callee may be allowed to prioritize available devices for an incoming call from the caller. The available devices or the priority list of devices may be defined differently depending on current geographic location of the callee. Further, the callee can specify different types of available devices and/or a different priority list of devices depending on the time of day. For example, the callee specifies a mobile device during lunch hours, a computer in the afternoon, a home phone after work hour, etc. Any type of criteria may be specified for defining a priority list and those provided herein are used an example only. At block 1606, the service provider identifies the device with the highest priority based on the determined priority list.

At decision block 1608, a determination is made as to whether the identified device is available (whether the identified device is in operation, not busy answering other calls, etc.) for the communication channel. If it is determined at decision block 1608 that the identified device is available, at block 1614, the contextual information relating to the available callee device is sent to the service provider. A communication channel is established between the caller device (which initiated the communication channel) and the available callee device. If it is determined at decision block 1608 that the identified device is not available, at decision block 1610, a determination is made as to whether there is another device in the priority list. If it is determined at decision block 1610 that there is another device in the priority list, at block 1612, the next device in the priority list is selected. The routine 1600 returns back to decision block 1608. The routine 1600 repeats above-mentioned steps until there is no device left in the priority list. If it is determined at decision block 1610 that there is no more device in the priority list, at block 1616, a response may be provided that no callee device has been found to be appropriate for the communication channel connection. The routine 1600 completes at block 1618 and available callee device information is returned to the callee channel establishing routine 1500.

As with FIGS. 13 and 14, it is to be understood that the embodiments explained in conjunction with the routine 1500 and the subroutine 1600 are provided merely for example purposes. It is contemplated that routine 1500 and the subroutine 1600 can also be performed by VoIP clients or third party service provider.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for establishing a communication channel for a conversation between a first client and a second client, comprising:
receiving a request to initiate the communication channel from the first client;
obtaining contextual information from the second client in response to the request;
determining whether at least one client device of the second client is available for establishing the communication channel; and
in response to determining that at least one client device of the second client is available, establishing the communication channel between the first client and the second client using the at least one available client device.

2. The method of claim 1 wherein obtaining contextual information includes retrieving pre-obtained contextual information corresponding to the second client.

3. The method of claim 1, further comprising:
obtaining contextual information from the first client, the contextual information relating to the request to initiate the communication channel; and
comparing the first client contextual information and the second client contextual information.

4. The method of claim 3, further comprising:
if the first client designates a client device of the second client and the designated client device is one of the available client devices of the second client, selecting the designated client device for establishing the communication channel.

5. The method of claim 3, further comprising:
if the first client designates a client device of the second client and the designated client device is not one of the available client devices of the second client, selecting a client device from the at least one of the available client device for establishing the communication channel.

6. The method of claim 5 wherein selecting includes determining a priority of the available client devices and selecting the available client device with highest priority for establishing the communication channel.

7. The method of claim 6 wherein determining a priority of available client devices includes determining the priority of available client devices for the first client based on the second client contextual information.

8. The method of claim 3, further comprising:
in response to determining that there is no available client device of the second client, rejecting the request to initiate the communication channel.

9. The method of claim 1 wherein the at least one available client device is selected from a group of client devices which are capable of communicating a VoIP conversation.

10. A method for establishing a communication channel for a conversation between a caller and a callee, comprising:
initiating the communication channel connection;
obtaining callee-contextual information;
determining a calling priority of callee devices provided by the callee;
determining whether a callee device is available to connect to the caller; and
establishing the communication channel connection between the available callee device and the caller.

11. The method of claim 10, further comprising:
obtaining caller-contextual information relating to the initiation of the communication channel connection; and
comparing the caller-contextual information and the callee-contextual information to determine whether a callee device is available.

12. The method of claim 11 wherein the callee device is available if at least one client device at the callee is available for the communication channel connection.

13. The method of claim 12 wherein the available callee device is located in a specified geographic area.

14. The method of claim 13 wherein the specified geographic area is associated with a predetermined date and time.

15. The method of claim 12 wherein the callee device is available if the time information of the channel connection initiation corresponds to the time information specified by the callee.

16. The method of claim 12 wherein the callee is available if the caller is one of the calling parties specified by the callee.

17. A computer readable medium having computer executable components for exchanging data packets relating to a conversation over a communication channel, comprising:
a channel connection module for initiating a communication channel in response to a request from a caller and receiving the data packets, including contextual data packets and conversational data packets;
a contextual information processing module for processing the contextual data packets and identifying a priority list of callee client devices that are appropriate for a caller at a predetermined time; and
wherein the channel connection module establishes the communication channel connection with a client device of the caller and at least one client device of the callee identified in the priority list.

18. The computer readable medium of claim 17, wherein the channel connection module terminates the communication channel if there is no available client device of the callee identified in the priority list.

19. The computer readable medium of claim 17, wherein the identified priority list is specific to the caller.

20. The computer readable medium of claim 17, wherein at a predetermined time and geographic location, the contextual information processing module identifies a general priority list of callee client devices for any caller who requests to initiate the communication channel with the callee.
